(19) United States
(12) Patent Application Publication
(10) Pub. No.: US 2020/0047028 A1
(43) Pub. Date: Feb. 13, 2020

(54) MEASUREMENT METHOD, MEASUREMENT SYSTEM, AND STORAGE MEDIUM

(71) Applicant: FUJITSU LIMITED, Kawasaki-shi (JP)

(72) Inventor: HIDEO OKADA, Atsugi (JP)

(73) Assignee: FUJITSU LIMITED, Kawasaki-shi (JP)

(21) Appl. No.: 16/658,907

(22) Filed: Oct. 21, 2019

Related U.S. Application Data
(63) Continuation of application No. PCT/JP2017/021516, filed on Jun. 9, 2017.

(51) Int. Cl. A63B 24/00; G01B 11/24; A63B 71/06; A63B 5/11

(52) U.S. Cl. CPC A63B 24/0021; G01B 11/24; A63B 71/0669; A63B 5/11; A63B 2024/0043; A63B 24/0084; A63B 2220/805; A63B 2220/20; A63B 2220/62; A63B 24/0062

(57) ABSTRACT

A measurement method executed by a computer, the measurement method includes acquiring scan data indicating a distance to a dent region generated in a bed portion of a trampoline and a direction of the dent region from a laser scanner device arranged below the bed portion and which scans a direction approximately parallel to the bed portion with laser light; specifying a center position of the dent region based on the acquired scan data; and calculating a landing position of a player of a trampoline competition on the bed portion based on the specified center position.

### CROSS-REFERENCE TO RELATED APPLICATION

This application is a continuation application of International Application PCT/JP2017/021516 filed on Jun. 9, 2017 and designated the U.S., the entire contents of which are incorporated herein by reference.

### FIELD

The present invention relates to a measurement method, a measurement system, and a measurement program.

### BACKGROUND

In competitions where players compete for ranking on the basis of scoring by scorers, measuring techniques for measuring and quantifying movement of the players have been conventionally adopted to improve the fairness of the scoring. For example, in a trampoline competition, a score (Time (T) score: one point per second) is added according to a total jump time. Therefore, a measuring technique for measuring the movement of a player being played to calculate the total jump time has been adopted.

Specifically, a device that projects laser light and a device that receives the laser light are arranged to face each other under a bed portion of a trampoline, and the presence or absence of interruption of the laser light of when the player lands on the bed portion of the trampoline to generate a dent in the bed portion is detected. Thereby, a non-jump time of the player can be measured. Therefore, a time in which the laser light is not interrupted (that is, the total jump time) is calculated backward from the measured non-jump time.
Non-Patent Document 1: FIG Apparatus Norms, [online], 2017, [Search on Jun. 2, 2017], Internet (URL: http://www.fig-gymnastics.com/publicdir/rules/files/app-norms/Apparatus%20Norms%20I-III%20E-%20Version %202017-e_.pdf)
Non-Patent Document 2: TIME MEASUREMENT DEVICE (TMD-3) DATA SHEET AND INSTRUCTIONS, [online], 2017, [Search on Jun. 2, 2017], Internet (URL: http://acrosport.ru/files/TMD-3_datasheet_en.pdf)

Here, in the case of a trampoline competition, a landing position (an amount of displacement in a horizontal direction) of when the player has landed has also been determined to be scored in the future. For this reason, a measuring technique for calculating the landing position of the player is required in addition to the total jump time of the player. In consideration of such circumstances, it is desirable to be capable of providing a measuring technology of calculating a landing position of when a player of a trampoline competition lands on a bed portion.

### SUMMARY

According to one aspect of the embodiments, a measurement method executed by a computer, the measurement method includes acquiring scan data indicating a distance to a dent region generated in a bed portion of a trampoline and a direction of the dent region from a laser scanner device arranged below the bed portion and which scans a direction approximately parallel to the bed portion with laser light; specifying a center position of the dent region based on the acquired scan data; and calculating a landing position of a player of a trampoline competition on the bed portion based on the specified center position.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of a system configuration of a measurement system;

FIG. 2 is a diagram illustrating a scanning direction of laser light emitted from a laser scanner device;

FIG. 3 is a diagram illustrating an example of an H score calculation table;

FIG. 4 is a diagram illustrating an example of a hardware configuration of a data processing device;

FIG. 5 is a first diagram illustrating an example of a functional configuration of the data processing device;

FIG. 6 is a diagram illustrating an example of scan data in a case where a player is in a jumping state;

FIG. 7 is a diagram illustrating an example of scan data in a case where a player is in a non-jumping state;

FIG. 8 is a diagram illustrating a specific example of a fitted circular shape;

FIG. 9 is a diagram illustrating a specific example of landing position information;

FIG. 10 is a flowchart illustrating a flow of landing position measuring processing;

FIG. 11 is a first diagram illustrating a specific example of a score calculation result;

FIG. 12 is a second diagram illustrating an example of a functional configuration of the data processing device;

FIG. 13 is a diagram illustrating a specific example of a total jump time;

FIG. 14 is a flowchart illustrating a flow of landing position and total jump time measuring processing;

FIG. 15 is a second diagram illustrating a specific example of the score calculation result.

### DESCRIPTION OF EMBODIMENTS

Hereinafter, embodiments will be described with reference to the attached drawings. Note that, in the description and the drawings, components having substantially the same functional configuration are denoted by the same reference numerals, and redundant description is omitted.

### First Embodiment

<System Configuration of Measurement System>

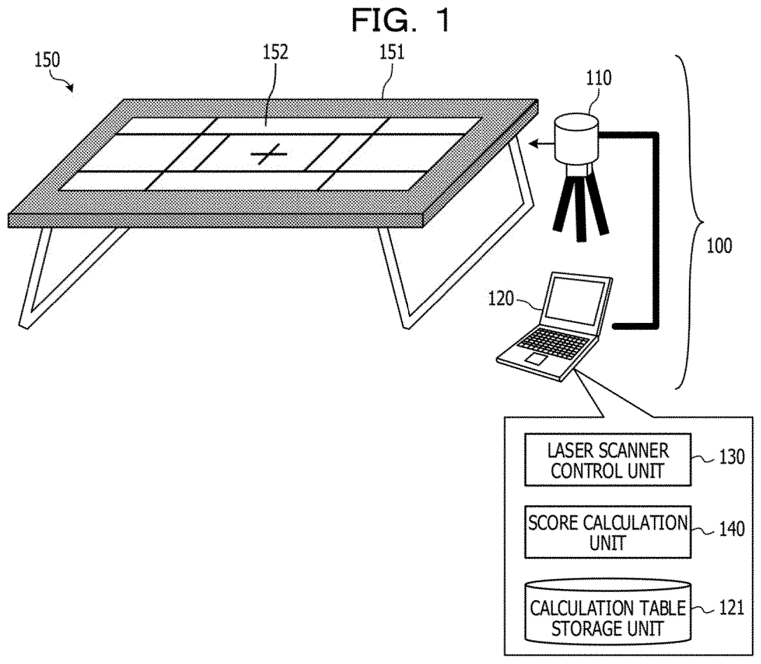

First, a system configuration of a measurement system for measuring and qualifying play of a player in a trampoline competition will be described. FIG. 1 is a diagram illustrating an example of a system configuration of a measurement system. As illustrated in FIG. 1, a measurement system 100 includes a laser scanner device 110 and a data processing device 120. The laser scanner device 110 and the data processing device 120 are communicatively connected.

The laser scanner device 110 is a measurement device provided with a scan function to execute, in an arbitrary direction in a predetermined plane, distance-measuring processing of measuring a time from emission of laser light to reception of reflected light to measure the distance to a reflecting object.

In a first embodiment, the laser scanner device 110 is arranged blow a bed portion 152 held via a spring by a frame 151 of a trampoline 150, and emits the laser light in a direction approximately parallel to the bed portion 152. Thereby, the laser scanner device 110 receives reflected light from a dent region generated in the bed portion 152 and can measure the distance to the dent region and the direction of the dent region.

The laser scanner device 110 transmits scan data including distance information indicating the distance to the dent region and angle information indicating the direction of the dent region to the data processing device 120.

A laser scanner control program and a score calculation program are installed in the data processing device 120 as measurement programs. The data processing device 120 functions as a laser scanner control unit 130 and a score calculation unit 140 as a CPU 401 executes the programs.

The laser scanner control unit 130 controls start and stop of the laser scanner device 110. Furthermore, the laser scanner control unit 130 sets various parameters of the laser scanner device 110.

The score calculation unit 140 acquires the scan data from the laser scanner device 110 and calculates a cross-sectional shape of the dent region generated in the bed portion 152, thereby calculating a landing position of the player on the bed portion 152. Furthermore, the score calculation unit 140 specifies a score (H score (horizontal displacement)) according to the calculated landing position (the amount of displacement in the horizontal direction) by reference to a calculation table storage unit 121, and outputs a score calculation result

<Scanning Direction with Laser Light>

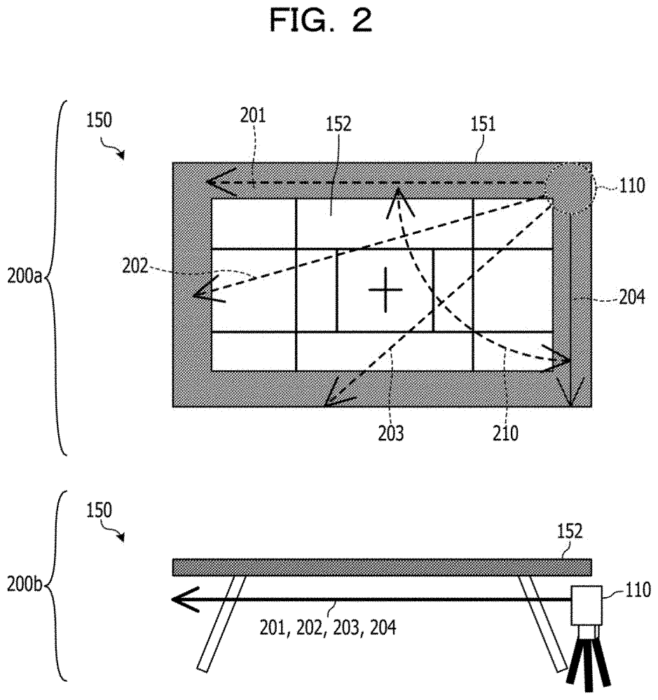

Next, a scanning direction of the laser light emitted from the laser scanner device 110 will be described. FIG. 2 is a diagram illustrating a scanning direction of laser light emitted from a laser scanner device. In FIG. 2, 200a in FIG. 2 illustrates a state of the trampoline 150 viewed from above and 200b in FIG. 2 illustrates a state of the trampoline 150 viewed from a side.

As illustrated in 200a in FIG. 2, in a case where the laser scanner device 110 is arranged at any of vertex positions of the rectangular frame 151, the laser scanner device 110 emits the laser light in a scan range 210 that ranges from a long side direction to a short side direction of the rectangular frame 151. Note that laser light 201 indicates the laser light emitted in the long side direction of the frame 151, and laser light 204 indicates the laser light emitted in the short side direction of the frame 151.

Furthermore, the laser scanner device 110 repeats emission and reception of the laser light during scanning the scan range 210. The laser light 202 and 203 indicates examples of the laser light emitted during scanning the scan range 210.

The entire surface of the bed portion 152 is set as the scan range in this way, whereby the laser scanner device 110 can measure the distance to the dent region generated in an arbitrary position of the bed portion 152 and the direction of the dent region.

Furthermore, as illustrated in 200b in FIG. 2, the laser light (for example, laser light 201 to 204) emitted by the laser scanner device 110 during scanning the scan range 210 is approximately parallel to the bed portion 152, the distance of the laser light from the bed portion 152 is constant.

The laser scanner device 110 scans the direction approximately parallel to the bed portion 152 in this way, whereby the laser scanner device 110 can measure the distance to the dent region generated in the bed portion 152 and the direction of the dent region at a certain height position from the bed portion 152.

<Calculation Table>

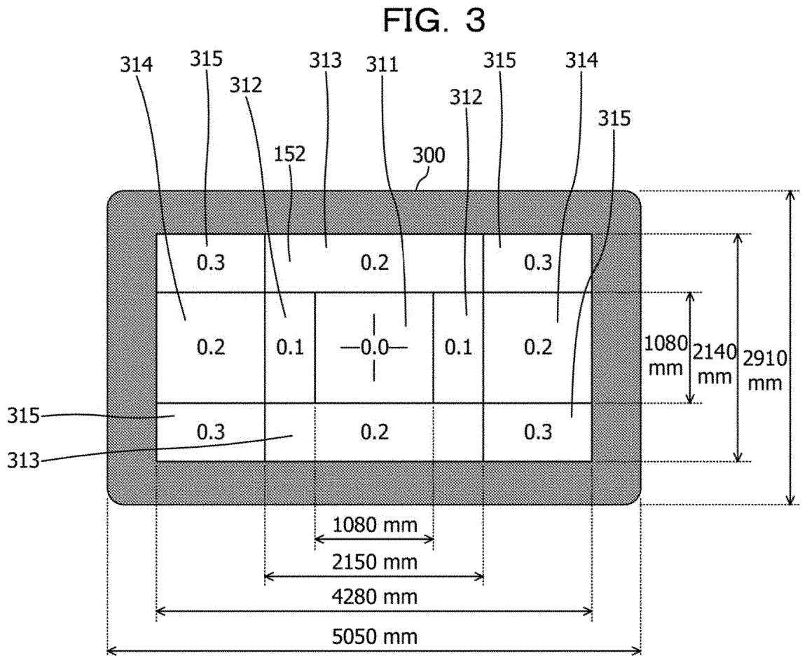

Next, an H score calculation table stored in the calculation table storage unit 121 will be described. FIG. 3 is a diagram illustrating an example of an H score calculation table. As illustrated in FIG. 3, an H score calculation table 300 is generated by dividing the bed portion 152 into a plurality of regions and assigning H scores to the respective regions.

Furthermore, as illustrated in FIG. 3, the trampoline 150 has a size of 2910 mm in length and 5050 mm in width. In the trampoline 150, the bed portion 152 has a size of 2140 mm in length and 4280 mm in width.

In a trampoline competition, the bed portion 152 with the size is divided into five types of regions (eleven sections) and the H score is scored. Note that the H score is scored by a deduction system.

Specifically, a region 311 of 1080 mm in length and 1080 mm in width including the center of the bed portion 152 is set as a region of the H score=0.0 points. In the case where the landing position of the player is included in the region 311, the player will not be deducted.

Furthermore, a region 312 excluding the region 311, of a region of 1080 mm in length and 2150 mm in width including the center of the bed portion 152, is set as a region of the H score=0.1 points. In the case where the landing position of the player is included in the region 312, the player will be deducted by 0.1 points.

Furthermore, a region 313 excluding the regions 311 and 312, of a region of 2140 mm in length and 2150 mm in width including the center of the bed portion 152, is set as a region of the H score=0.2 points. In the case where the landing position of the player is included in the region 313, the player will be deducted by 0.2 points.

Furthermore, a region 314 excluding the regions 311 and 312, of a region of 1080 mm in length and 4280 mm in width including the center of the bed portion 152, is set as a region of the H score=0.2 points. Therefore, in the case where the landing position of the player is included in the region 314, the player will be deducted by 0.2 points.

Moreover, a region 315 other than the above regions 311 to 314 in the bed portion 152 is set as a region of the H score=0.3 points. In the case where the landing position of the player is included in the region 315, the player will be deducted by 0.3 points.

<Hardware Configuration of Data Processing Device>

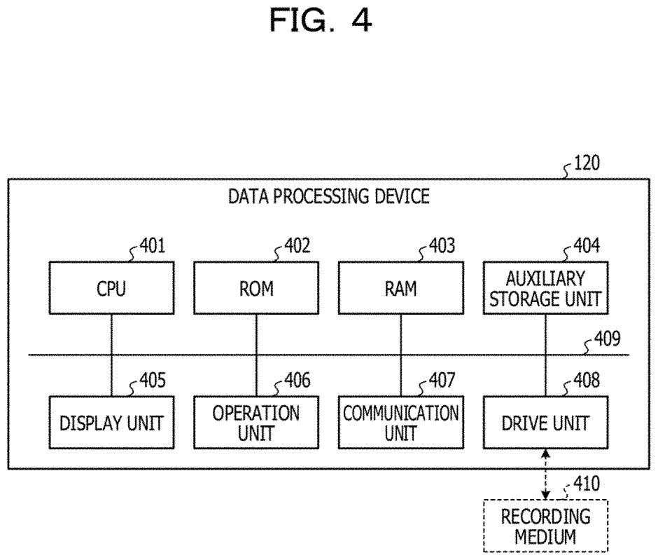

Next, a hardware configuration of the data processing device 120 will be described. FIG. 4 is a diagram illustrating an example of a hardware configuration of the data processing device.

As illustrated in FIG. 4, the data processing device 120 includes a central processing unit (CPU) 401, a read only memory (ROM) 402, and a random access memory (RAM) 403. The CPU 401, ROM 402, and RAM 403 form a so-called computer. Furthermore, the data processing device 120 includes an auxiliary storage unit 404, a display unit 405, an operation unit 406, a communication unit 407, and a drive unit 408. Note that the units of the data processing device 120 are connected to one another via a bus 409.

The CPU 401 executes various programs (for example, the laser scanner control program, the score calculation program, and the like) Installed in the auxiliary storage unit 404.

The ROM 402 is a nonvolatile memory. The ROM 402 functions as a main storage device that stores various programs, data, and the like necessary for the CPU 401 to execute the various programs installed in the auxiliary storage unit 404. More specifically, the ROM 402 stores a boot program or the like of a basic input/output system (BIOS), an extensible firmware interface (EFI), and the like.

The RAM 403 is a volatile memory such as a dynamic random access memory (DRAM) or a static random access memory (SRAM). The RAM 403 functions as a main storage device that provides a work area expanded when the CPU 401 executes the various programs installed in the auxiliary storage unit 404.

The auxiliary storage unit 404 is an auxiliary storage device that stores various programs installed in the data processing device 120, data used when the various programs are executed, and the like. The above-described calculation table storage unit 121 is realized in the auxiliary storage unit 404.

The display unit 405 is a display device that displays a processing result or the like (for example, a score calculation result) by the data processing device 120. The operation unit 406 is an operation device used when an administrator of the measurement system 100 inputs various instructions (for example, a measurement start instruction and a measurement end instruction to be described below) to the data processing device 120. The communication unit 407 is a communication device for the data processing device 120 to communicate with the laser scanner device 110.

The drive unit 408 is a device for setting a recording medium 410. The recording medium 410 referred here includes a medium for optically, electrically, or magnetically recording information, such as a CD-ROM, a flexible disk, or a magneto-optical disk. Alternatively, the recording medium 410 may include a semiconductor memory or the like that electrically records information, such as a ROM or a flash memory.

Note that the various programs stored in the auxiliary storage unit 404 are installed by, for example, setting the distributed recording medium 410 to the drive unit 408 and reading the various programs recorded on the recording medium 410 by the drive unit 408. Alternatively, the various programs stored in the auxiliary storage unit 404 may be installed by being downloaded from a network via the communication unit 407.

<Functional Configuration of Data Processing Device>

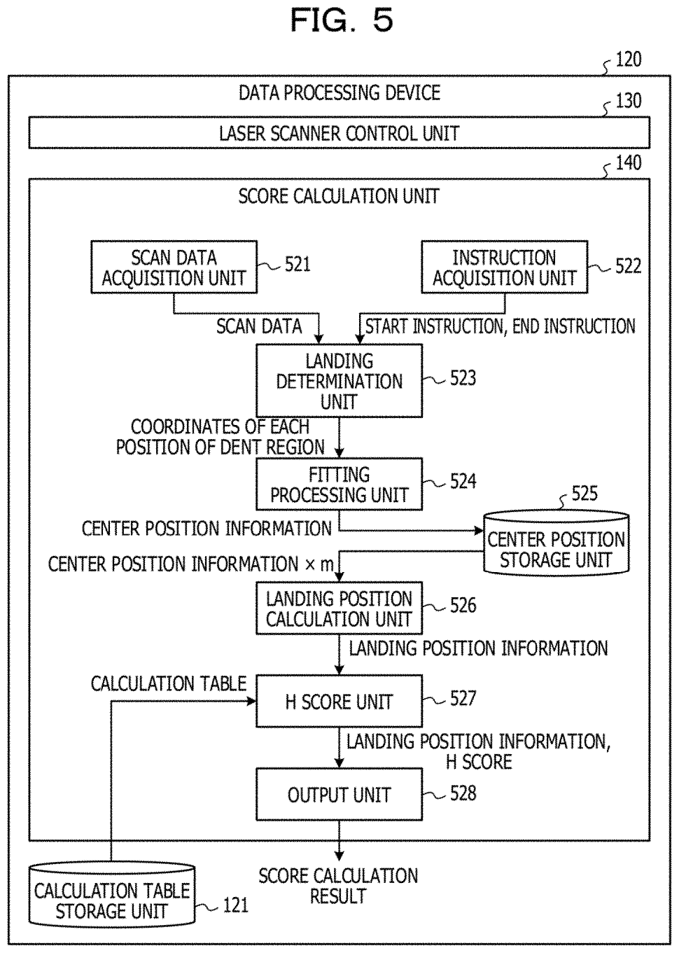

Next, a functional configuration of the data processing device 120 will be described. FIG. 5 is a first diagram illustrating an example of a functional configuration of the data processing device. As described above, the data processing device 120 functions as the laser scanner control unit 130 and the score calculation unit 140. Here, the functional configuration of the score calculation unit 140 will be described in detail.

As illustrated in FIG. 5, the score calculation unit 140 includes a scan data acquisition unit 521, an instruction acquisition unit 522, a landing determination unit 523, a fitting processing unit 524, a landing position calculation unit 526, an H score unit 527, and an output unit 528.

The scan data acquisition unit 521 is an example of an acquisition unit, and acquires the scan data transmitted from the laser scanner device 110 and notifies the landing determination unit 523 of the scan data. As described above, the scan data includes the distance information indicating the distance from the laser scanner device 110 to the dent region of the bed portion 152 and the angle information indicating the direction of the dent region of the bed portion 152 of when viewed from the laser scanner device 110.

Note that scan data scanned in a state where no dent region is generated in the bed portion 152, of the scan data acquired by the scan data acquisition unit 521, is stored in the distance information as a predetermined default value. This is because, in the case where no dent region is generated in the bed portion 152, the laser scanner device 110 cannot receive the reflected light and is unable to measure the distance and thus stores the default value in the distance information and transmits the distance information.

For a similar reason, a default value is stored in distance information based on the laser light emitted toward a region other than the dent region generated in the bed portion 152, of the distance information included in the scan data acquired by the scan data acquisition unit 521.

The instruction acquisition unit 522 acquires the measurement start instruction and the measurement end instruction input by the administrator of the measurement system 100. The instruction acquisition unit 522 notifies the landing determination unit 523 of the acquired measurement start instruction and the measurement end instruction.

When the landing determination unit 523 receives the measurement start instruction from the instruction acquisition unit 522, the landing determination unit 523 starts processing for the scan data notified from the scan data acquisition unit 521. Specifically, the landing determination unit 523 converts the scan data into two-dimensional coordinates with the center of the bed portion 152 as the origin, and calculates coordinates indicating the position of the dent region on a two-dimensional coordinate plane. Furthermore, the landing determination unit 523 determines whether the player of the trampoline competition has landed on the bed portion 152 (whether the player has transitioned to a non-jumping state) on the basis of whether the calculated coordinates are included in the bed portion 152.

Moreover, when the landing determination unit 523 determines that the player of the trampoline competition has transitioned to the non-jumping state, the landing determination unit 523 notifies, from here onward, the fitting processing unit 524 of coordinates of each position of a dent region (which are limited to coordinates indicating a position in the bed portion 152) until the player is determined to have transitioned to a jumping state.

The processing by the landing determination unit 523 is continued until the instruction acquisition unit 522 receives the measurement end instruction from the instruction acquisition unit 522.

The fitting processing unit 524 plots, on the two-dimensional coordinate plane, the coordinates indicating each position of the dent region calculated by the landing determination unit 523, and fits a circular shape to the plotted position. As a fitting method performed by the fitting processing unit 524, an arbitrary method such as a method using a least square method or a method using a Hough transform can be applied.

Note that the circular shape obtained by fitting is equal to the cross-sectional shape of when the dent region is cut by a plane approximately parallel to the bed portion 152. Here, assuming that the dent region generated when the player lands on the bed portion 152 has an even shape centered on the landing position, a center position of the circular shape obtained by fitting can be said to represent the landing position of the player.

Therefore, the fitting processing unit 524 calculates the center position of the circular shape obtained by fitting, and stores coordinates of the calculated center position in a center position storage unit 525 as center position information of the player.

Here, assuming that the laser scanner device 110 performs scanning a plurality of times (for example, m times) while the player is in the non-jumping state. In this case, the fitting processing unit 524 stores m pieces of the center position information in the center position storage unit 525. Note that the “while the player is in the non-jumping state” refers to a time from when the player is determined to have transitioned to the non-jumping state to when the player is determined to have transitioned to the jumping state.

The landing position calculation unit 526 is an example of a calculation unit, and reads the m pieces of center position information stored in the center position storage unit 525 and calculates average position coordinates, thereby calculating the coordinates indicating the landing position. The landing position calculation unit 526 notifies the H score unit 527 of the calculated coordinates indicating the landing position as landing position information.

The H score unit 527 reads the H score calculation table 300 stored in the calculation table storage unit 121 and compares the H score calculation table 300 with the landing position information notified from the landing position calculation unit 526 to specify the H score of the player. Furthermore, the H score unit 527 notifies the output unit 528 of the specified H score together with the landing position information.

The output unit 528 displays, on the display unit 405, the landing position information and the H score notified from the H score unit 527, as a score calculation result.

<Specific Example of Scan Data>

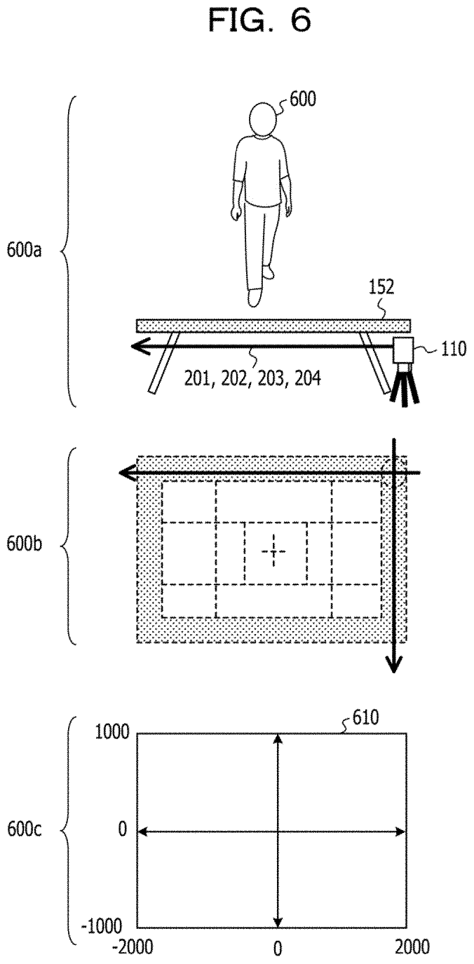

Next, a specific example of the scan data, which has been acquired by the scan data acquisition unit 521, converted into the two-dimensional coordinates by the landing determination unit 523, and plotted by the fitting processing unit 524, will be described in association with each state of the player during the trampoline competition. FIG. 6 is a diagram illustrating an example of the scan data in the case where the player is in the jumping state.

As Illustrated in 600a in FIG. 6, in the case where a player 600 is in the jumping state, no dent region is generated in the bed portion 152. Therefore, the laser light 201 to 204 emitted by the laser scanner device 110 is not reflected at the bed portion 152 (600b in FIG. 6), and the default value is stored in the distance information included in the scan data. In this case, nothing is plotted on a two-dimensional coordinate plane 610, as illustrated in 600c in FIG. 6.

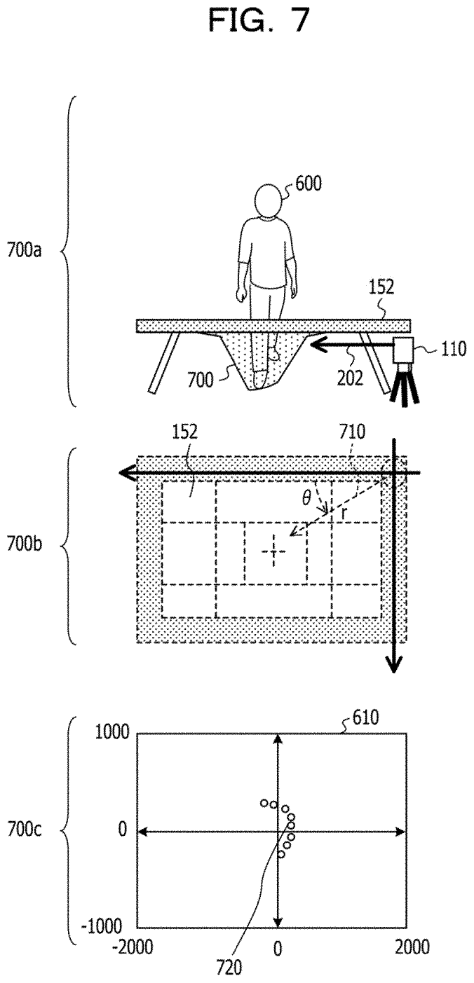

Meanwhile, FIG. 7 is a diagram illustrating an example of the scan data in the case where the player is in the non-jumping state. As illustrated in 700a in FIG. 7, in the case where the player 600 is in the non-Jumping state, a dent region 700 is generated in the bed portion 152. Therefore, the laser light 202, for example, of the laser light 201 to 204 emitted by the laser scanner device 110, is reflected at the dent region in the bed portion 152. Therefore, the scan data including the distance information (r) indicating the distance to the dent region and the angle information (8) indicating the direction of the dent region is transmitted to the data processing device 120 (scan data 710 in 700b in FIG. 7).

In this case, as illustrated in 700c in FIG. 7, the landing determination unit 523 converts the scan data (the scan data 710, for example) into two-dimensional coordinates, and the fitting processing unit 524 plots the converted coordinates on the two-dimensional coordinate plane 610 as a point 720. Note that the example in 700c in FIG. 7 illustrates a case in which eight data of the scan data including the distance information indicating the distance to the dent region and the angle information indicating the direction of the dent region are acquired in single time of scanning. For this reason, eight points including the point 720 are plotted on the two-dimensional coordinate plane 610.

<Specific Example of Fitted Circular Shape>

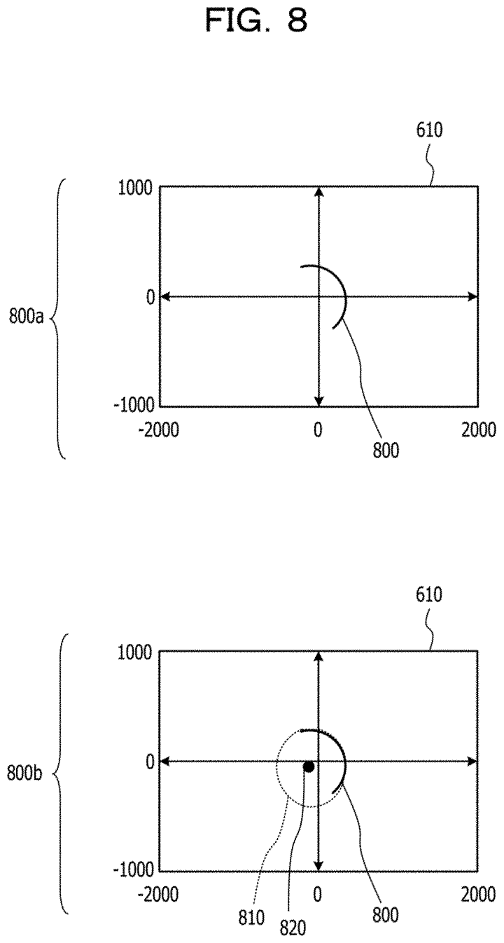

Next, a specific example of the circular shape fitted by the fitting processing unit 524 will be described. FIG. 8 is a diagram illustrating a specific example of a fitted circular shape. In FIG. 8, 800a in FIG. 8 illustrates an approximate curve 800 obtained by approximating scan data plotted on the two-dimensional coordinate plane 610.

Here, the fitting processing unit 524 calculates a circular shape that minimizes the sum of squares of a residual from the approximate curve 800. In 800b in FIG. 8, a circular shape 810 indicates the circular shape that minimizes the sum of squares of a residual from the approximate curve 800, and a point 820 indicates a center position of the circular shape 810. The coordinates of the point 820 on the two-dimensional coordinate plane 610 are stored in the center position storage unit 525 as center position information.

<Specific Example of Landing Position Information>

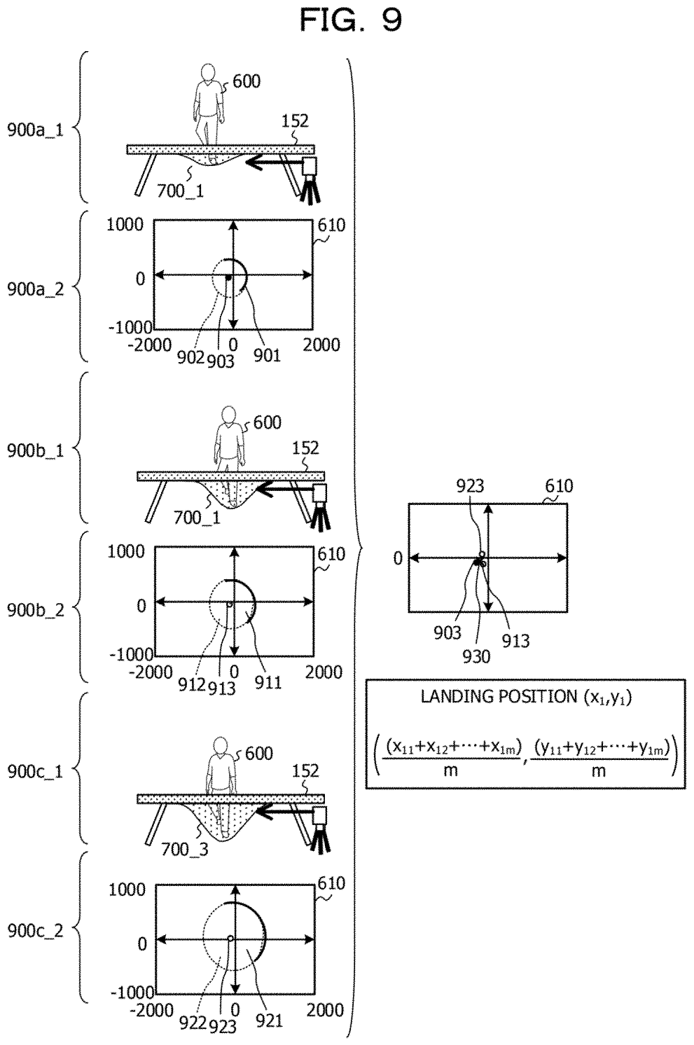

Next, a specific example of the landing position information calculated by the landing position calculation unit 526 will be described. FIG. 9 is diagrams illustrating a specific example of the landing position information. In FIG. 9, 900a_1, 900b_1, and 900c_1 in FIG. 9 respectively illustrate states of the player 600 in the non-jumping state.

Specifically, 900a_1 in FIG. 9 illustrates a state immediately after the player 600 has transitioned to the non-jumping state, and the amount of dent in a dent region 700_1 is small. Meanwhile, 900b_1 in FIG. 9 illustrates a state after the amount of dent in the dent region becomes larger than the state immediately after the transition to the non-jumping state (the size of the dent region 700_2>the size of the dent region 700_1). Moreover, 900c_1 in FIG. 9 illustrates a state of when the dent region becomes maximum (the size of the dent region 700_3>the dent region 700_2).

900a_2, 900b_2, and 900c_2 in FIG. 9 illustrate states where the center position information is calculated by scanning in the respective non-jumping states. For example, in 900a_2 in FIG. 9, an approximate curve 901 is a curve obtained by converting the scan data acquired in the non-jumping state illustrated in 900a_1 in FIG. 9 into two-dimensional coordinates and approximating the points plotted on the two-dimensional coordinate plane 610. Furthermore, a circular shape 902 is a circular shape that minimizes the sum of squares of a residual from the approximate curve 901. Moreover, a center position 903 is the center position of the circular shape 902.

Similarly, in 900b_2 in FIG. 9, an approximate curve 911 is a curve obtained by converting the scan data acquired in the non-jumping state illustrated in 900b_1 in FIG. 9 into two-dimensional coordinates and approximating the points plotted on the two-dimensional coordinate plane 610. Furthermore, a circular shape 912 is a circular shape that minimizes the sum of squares of a residual from the approximate curve 911. Moreover, a center position 913 is the center position of the circular shape 912.

Similarly, in 900c_2 in FIG. 9, an approximate curve 921 is a curve obtained by converting the scan data acquired in the non-jumping state illustrated in 900c_1 in FIG. 9 into two-dimensional coordinates and approximating the points plotted on the two-dimensional coordinate plane 610. Furthermore, a circular shape 922 is a circular shape that minimizes the sum of squares of a residual from the approximate curve 921. Moreover, a center position 923 is the center position of the circular shape 922.

The landing position calculation unit 526 calculates coordinates (average position coordinates) of an average position 930 of the center positions 903, 913, 923, . . . calculated by the scanning in the respective non-Jumping states to calculate the coordinates indicating the landing position.

Here, the coordinates of the center position 903 are (x₁₁, y₁₁), the coordinates of the center position 913 are (x₁₂, y₁₂), the coordinates of the center position 923 are (x₁₃, y₁₃), and the coordinates of the center position calculated on the basis of m-th scanning are (x₁ₘ, y₁ₘ). In this case, coordinates (x₁, y₁) indicating the landing position during the first transition in the non-jumping state, which are calculated by m times of scanning, can be calculated by the following expression.

$$( {x}_{1} , {y}_{1} ) = ( \frac{( {x}_{11} + {x}_{12} + … + {x}_{1 m} )}{m} , \frac{( {y}_{11} + {y}_{12} + … + {y}_{1 m} )}{m} ) \qquad [ Math . 1 ]$$

<Flow of Landing Position Measuring Processing>

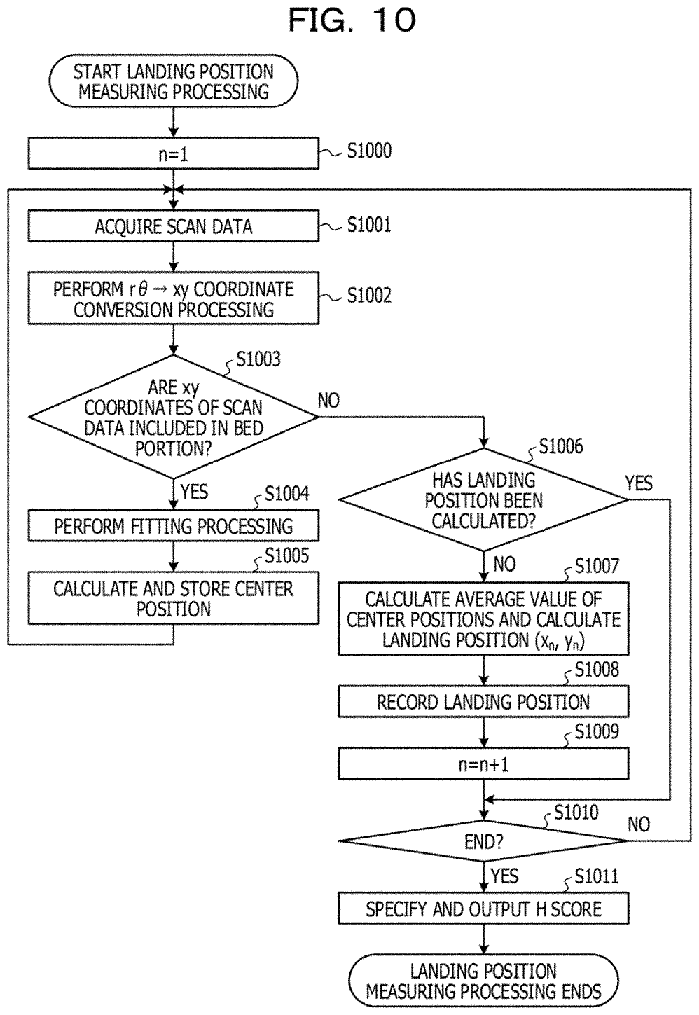

Next, a flow of landing position measuring processing in the score calculation unit 140 will be described. FIG. 10 is a flowchart illustrating a flow of landing position measuring processing. When the measurement start instruction is received from the instruction acquisition unit 522, the landing position measuring processing illustrated in FIG. 10 is executed.

In step S1000, the landing determination unit 523 substitutes 1 for the number of transitions to the non-jumping state (n).

In step S1001, the landing determination unit 523 acquires the scan data notified from the scan data acquisition unit 521.

In step S1002, the landing determination unit 523 converts the distance information (r) and the angle information (θ) included in each acquired scan data for one time of scanning into two-dimensional coordinates (rθ→xy).

In step S1003, the landing determination unit 523 determines whether each scan data for one time of scanning converted into two-dimensional coordinates is included in the bed portion 152. In the case where the each scan data is determined to be included in the bed portion 152 in step S1003 (in the case of Yes in step S1003), the processing proceeds to step S1004.

In step S1004, the fitting processing unit 524 calculates the approximate curve of the scan data for one time of scanning converted into two-dimensional coordinates, and fits a circular shape.

In step S1004, the fitting processing unit 524 calculates the center position of the fitted circular shape and stores the center position in the center position storage unit 525 as the center position information.

On the other hand, in the case where the each scan data is determined not to be included in the bed portion 152 in step S1003 (in the case of No in step S1003), the processing proceeds to step S1006.

In step S1006, the landing position calculation unit 526 determines whether having calculated the coordinates indicating the landing position on the basis of the center position information stored in the center position storage unit 525. In the case where the landing position calculation unit 526 determines not to have calculated the coordinates indicating the landing position in step S1006, the processing proceeds to step S1007.

In step S1007, the landing position calculation unit 526 calculates the average position coordinates on the basis of the center position information to calculate coordinates (xₙ, yₙ) indicating the landing position during the n-th transition in the non-jumping state. Furthermore, in step S1008, the landing position calculation unit 526 records, to the score calculation result, the calculated coordinates (xₙ, yₙ) indicating the landing position during the n-th transition in the non-jumping state as the landing position information.

In step S1009, the landing position calculation unit 526 increments the number of transitions to the non-jumping state (n).

In step S1010, the landing determination unit 523 determines whether having received an end instruction from the instruction acquisition unit 522. In the case of determining that the landing determination unit 523 has not received the end instruction from the instruction acquisition unit 522 in step S1010, the processing returns to step S1001.

On the other hand, in the case of determining that the landing determination unit 523 has received the end instruction from the instruction acquisition unit 522 in step S1010, the processing proceeds to step S1011. In step S1011, the H score unit 527 specifies an H score according to the landing position information of each time by reference to the H score calculation table 300, and outputs the score calculation result including the landing position information and the H score.

<Specific Example of Score Calculation Result>

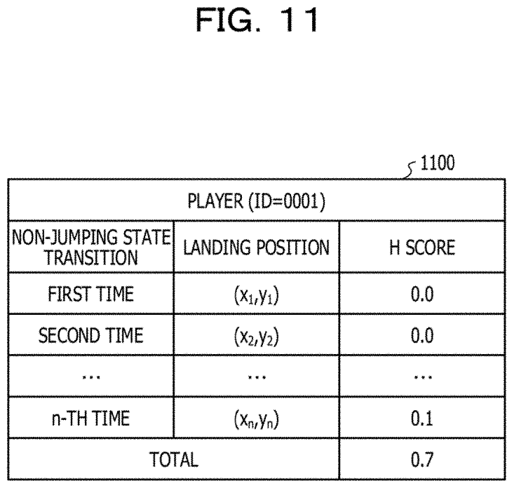

Next, a specific example of the score calculation result output from the output unit 528 will be described. FIG. 11 is a first diagram illustrating a specific example of a score calculation result. As illustrated in FIG. 11, the score calculation result 1100 includes “ID” for identifying the player, “non-jumping state transition”, “landing position”, and “H score” as items of information.

In the “ID”, an identifier for identifying each player is stored. In the “non-jumping state transition”, the number of transitions to the non-jumping state (n) in which the player 600 has transitioned to the non-jumping state in the trampoline competition is stored. In the “landing position”, the landing position information calculated using the scan data acquired by m times of scanning by the laser scanner device 110 while the player 600 is in the non-jumping state is stored.

In the “H score”, the H score of each time specified by comparing the landing position information stored in the corresponding “landing position” with the H score calculation table 300 is stored.

As is apparent from the above description, the measurement system according to the first embodiment includes the laser scanner device below the trampoline bed portion, the laser scanner device scanning the direction approximately parallel to the bed portion with the laser light. Then, the laser scanner device acquires the scan data indicating the distance to each position of the dent region generated in the bed portion and the direction of the each position of the dent region.

Furthermore, the measurement system according to the first embodiment converts the acquired scan data into two-dimensional coordinates, thereby calculating the shape of the cross section (fitted circular shape) of the dent region, and calculating the landing position of the player on the bed portion on the basis of the center position of the cross section.

Thus, according to the measurement system in the first embodiment, the landing position of when the player of the trampoline competition lands on the bed portion can be calculated.

### Second Embodiment

In the measurement system according to the first embodiment, the function to calculate the landing position of the player, which is used for scoring the H score, has been described. However, the function of the measurement system is not limited thereto, and, for example, a function to calculate a total jump time, which is used for scoring T score, may be further provided. Hereinafter, a second embodiment will be described focusing on differences from the first embodiment.

<Functional Configuration of Data Processing Device>

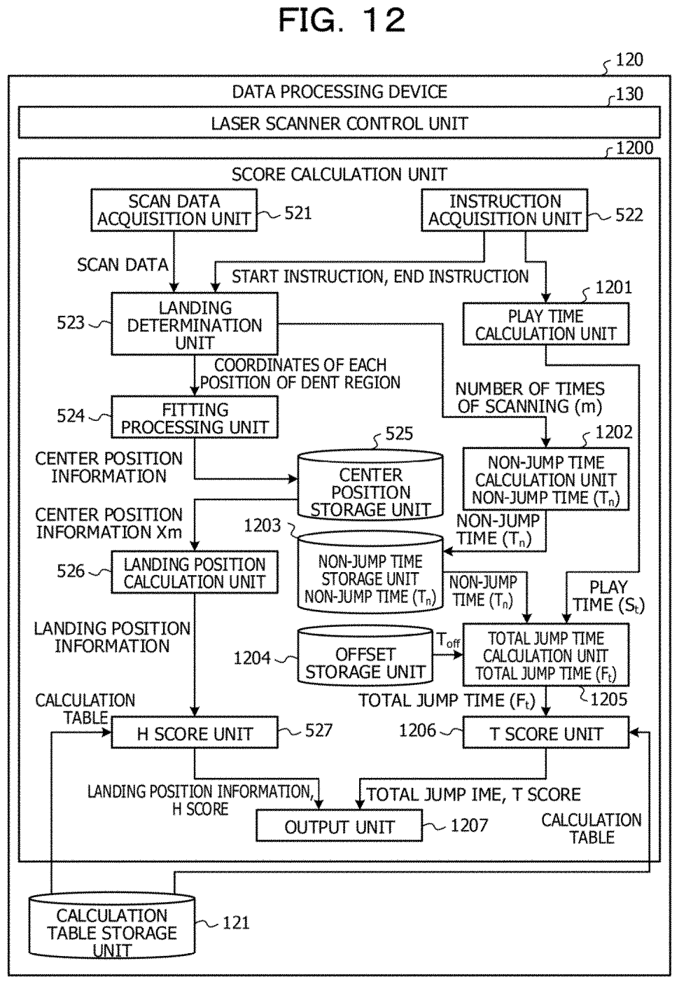

First, a functional configuration of a data processing device 120 in a second embodiment will be described. FIG. 12 is a second diagram illustrating an example of a functional configuration of the data processing device. In the case of FIG. 12, the difference from the functional configuration illustrated in FIG. 5 is that a score calculation unit 1200 includes a play time calculation unit 1201, a non-jump time calculation unit 1202, a total jump time calculation unit 1205, a T score unit 1206, and an output unit 1207.

When having received a measurement start instruction from an instruction acquisition unit 522, the play time calculation unit 1201 starts measurement of a play time. Furthermore, when having received a measurement end instruction, the play time calculation unit 1201 terminates the measurement of the play time. Thereby, the play time calculation unit 1201 can calculate the play time (Sₜ) of the player.

The non-jump time calculation unit 1202 acquires the number of times of scanning (m) by a laser scanner device 110 while a player is in a non-jumping state from a landing determination unit 523.

Furthermore, the non-jump time calculation unit 1202 multiplies the number of times of scanning (m) acquired from the landing determination unit 523 by a time (Pₜ) required for one time of scanning to calculate n-th non-jump time (Tₙ) (see the expression below). The non-jump time calculation unit 1202 stores the calculated non-jump time in a non-jump time storage unit 1203.

Tₙ=Pₜ×m [Math. 2]

The total jump time calculation unit 1205 reads each non-jump time (Tₙ) stored in the non-jump time storage unit 1203. Furthermore, the total jump time calculation unit 1205 acquires the play time (Sₜ) calculated by the play time calculation unit 1201. Moreover, the total jump time calculation unit 1205 reads a time (T_{off}) according to a distance (offset value) between a bed portion 152 and a scan surface, the distance being stored in an offset storage unit 1204.

The total jump time calculation unit 1205 calculates a total jump time (Fₜ) on the basis of each non-jump time (Tₙ), the play time (Sₜ), and the time (T_{off}) according to the offset value (see the expression below).

Fₜ=Sₜ−Σ(Tₙ+2×T_{off}) [Math. 3]

The T score unit 1206 specifies the score (T score) according to the total jump time (Fₜ) calculated in the total jump time calculation unit 1205 by reference to a T score calculation table stored in a calculation table storage unit 121. Note that the calculation table storage unit 121 stores a calculation table in which the T score (one point per second, for example) according to the total jump time is defined, in addition to an H score calculation table 300.

The T score unit 1206 notifies the output unit 1207 of the specified T score together with the total jump time (Fₜ).

The output unit 1207 displays, on a display unit 405, a score calculation result including landing position information and an H score notified from an H score unit 527, and a score calculation result including the total jump time and the T score notified from the T score unit 1206.

<Specific Example of Total Jump Time>

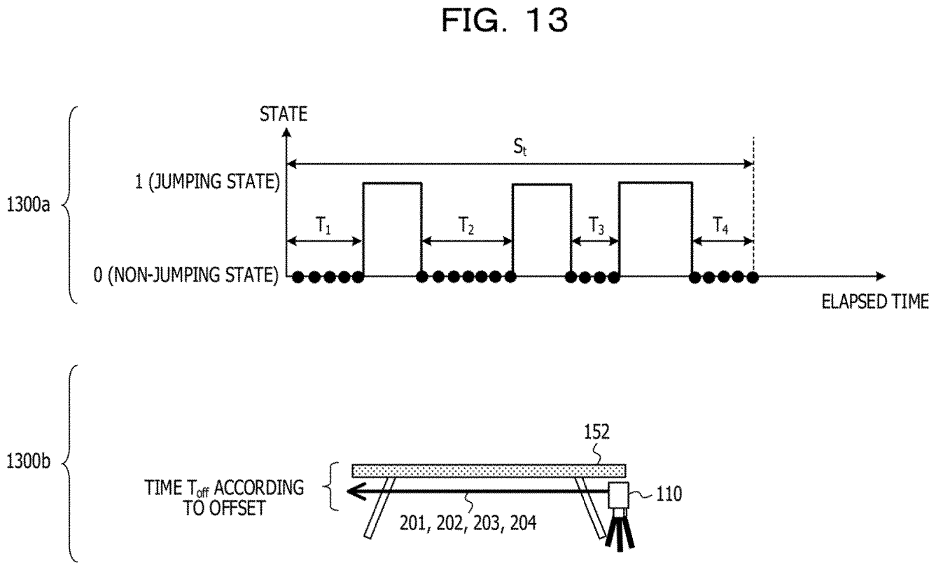

Next, a specific example of the total jump time calculated by the score calculation unit 1200 will be described. FIG. 13 is a diagram illustrating a specific example of the total jump time. In FIG. 13, 1300a in FIG. 13 is a graph with a horizontal axis representing an elapsed time from reception of a measurement start instruction and a vertical axis representing a state (a jumping state or a non-jumping state).

The example in 1300a in FIG. 13 illustrates a player has transitioned to the non-jumping state four times and has transitioned to the jumping state three times during the play time (Sₜ).

Furthermore, the example in 1300a in FIG. 13 illustrates that five times of scanning is performed by the laser scanner device 110 during the first transition in the non-jumping state, and T₁ is calculated as the non-jump time. Similarly, the example in 1300a in FIG. 13 illustrates that seven times of scanning is performed by the laser scanner device 110 during the second transition in the non-jumping state, and T₂ is calculated as the non-jump time. Similarly, the example in 1300a in FIG. 13 illustrates that four times of scanning is performed by the laser scanner device 110 during the third transition in the non-jumping state, and T₃ is calculated as the non-jump time. Similarly, the example in 1300a in FIG. 13 illustrates that five times of scanning is performed by the laser scanner device 110 during the fourth transition in the non-jumping state, and T₄ is calculated as the non-jump time.

1300b in FIG. 13 illustrates details of the time (T_{off}) according to the offset value stored in the offset storage unit 1204. As described above, laser light 201 to 204 is emitted in approximately parallel to the bed portion 152. The offset storage unit 1204 stores in advance a time according to an offset value that is a distance between the bed portion 152 and each of the laser light 201 to 204 (a time from when a dent region is generated in the bed portion 152 to when the offset value arrives: T_{off}).

According to the example in 1300a and 1300b in FIG. 13, the total jump time (Fₜ) calculated by the total jump time calculation unit 1205 is as follows.

Total Jump Time(Fₜ)=Sₜ−T₁−T₂−T₃−T₄−8×T_{off} [Math. 4]

<Flow of Landing Position and Total Jump Time Measuring Processing>

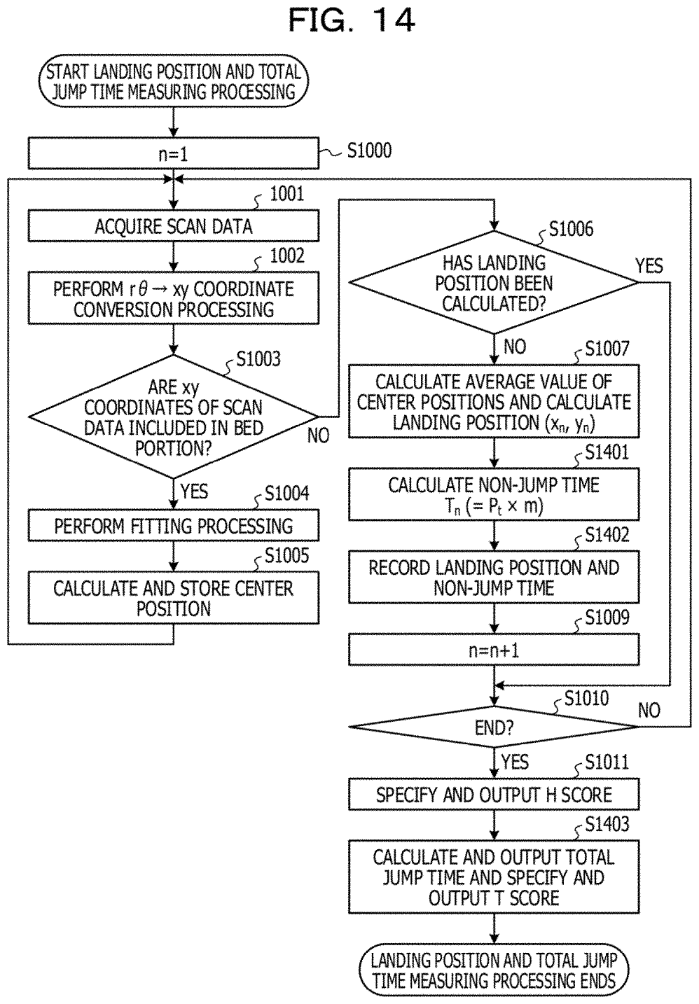

Next, a flow of landing position and total jump time measuring processing in the score calculation unit 1200 will be described. FIG. 14 is a flowchart illustrating a flow of landing position and total jump time measuring processing. Differences from the landing position measuring processing illustrated in FIG. 10 are steps S1401, S1402, and S1403.

In step S1401, the non-jump time calculation unit 1202 acquires the number of times of scanning (m) during a player 600 being in the non-jumping state from the landing determination unit 523, and multiplies the number of times of scanning (m) by the time (Pₜ) required for one time of scanning to calculate the non-jump time (Tₙ).

In step S1402, the landing position calculation unit 526 records, in a score calculation result, calculated coordinates (xₙ, yₙ) indicating a landing position as landing position information during the n-th transition in the non-jumping state. Furthermore, the non-jump time calculation unit 1202 records the n-th non-jump time (Tₙ) in the score calculation result.

In step S1403, the total jump time calculation unit 1205 calculates the total jump time (Fₜ) using each non-jump time (Tₙ), the play time (Sₜ), and the time (T_{off}) according to the offset value, and records the total jump time (Fₜ) in the score calculation result. Furthermore, the T score unit 1206 specifies the T score on the basis of the total jump time (Fₜ) and records the total jump time (Fₜ) in the score calculation result. Moreover, the output unit 1207 displays the score calculation result on the display unit 405.

<Specific Example of Score Calculation Result>

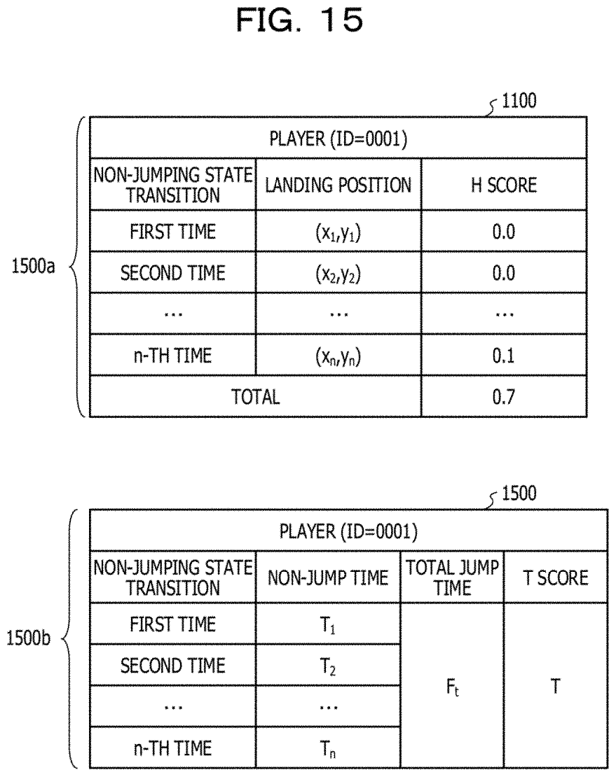

Next, a specific example of the score calculation result displayed by the output unit 1207 will be described. FIG. 15 is a second diagram illustrating a specific example of the score calculation result. In the second embodiment, the output unit 1207 displays a score calculation result 1500 (1500b in FIG. 15) including the T score in addition to a score calculation result 1100 (1500a in FIG. 15) including the H score.

As illustrated in 1500b in FIG. 15, the score calculation result 1500 includes “ID”, “non-jumping state transition”, “non-jump time”, “total jump time”, and “T score” as items of information.

In the “ID”, an identifier for identifying each player is stored. In the “non-jumping state transition”, the number of transitions to the non-jumping state (n) in which the player has transitioned to the non-jumping state in a trampoline competition is stored. In the “non-jump time”, the non-jump time of each time is stored. For example, a non-jump time (T₁) indicates the non-jump time during the first transition in the non-jumping state, a non-jump time (T₂) indicates the non-jump time during the second transition in the non-jumping state.

In the “total jump time”, the total jump time calculated using each non-jump time is stored. In the “T score”, the T score specified on the basis of the total jump time is stored.

As is apparent from the above description, the measurement system according to the second embodiment calculates the non-jump time on the basis of the scan data acquired by m times of scanning while the player is in the non-jumping state. Furthermore, the measurement system according to the second embodiment calculates the total jump time on the basis of the calculated non-jump time, the time according to the offset value, and the play time.

Thus, according to the measurement system in the second embodiment, the total jump time of the player of the trampoline competition can be calculated in addition to the landing position of when the player of the trampoline competition lands on the bed portion.

### OTHER EMBODIMENTS

In the first and second embodiments, the case in which one laser scanner device 110 is arranged at a vertex position of the rectangular frame 151 of the trampoline 150 has been described. However, the position of the laser scanner device 110 is not limited to a vertex position of the frame 151. Furthermore, the number of the laser scanner devices 110 is not limited to one, and may be two or more. By arranging two or more devices, the fitting accuracy can be further improved.

Furthermore, in the first embodiment, the case in which the coordinates indicating the landing position are calculated using the scan data acquired by m times of scanning during the player being in the non-jumping state has been described. However, the scan data used for calculating the coordinates indicating the landing position may be a part of the scan data acquired by the m times of scanning. For example, scan data obtained by scanning from when a dent region is generated as the player transitions to the non-jumping state to when the dent region becomes maximum may be used for calculating the coordinates indicating the landing position.

Furthermore, in the first embodiment, the case in which the landing determination unit 523 notifies the fitting processing unit 524 of all the coordinates included in the bed portion 152 has been described. However, coordinates notified by the landing determination unit 523 may be a part of the coordinates included in the bed portion 152. Specifically, coordinates included in a predetermined range of the bed portion 152 may be notified.

Furthermore, in the first embodiment, the case in which the fitting processing unit 524 performs the fitting using the circular shape has been described. However, the fitting processing unit 524 may perform the fitting using a shape (for example, an elliptical shape) other than the circular shape.

Furthermore, in the second embodiment, the non-jump time (Tₙ) is calculated on the basis of the number of times of scanning (m) during the player being in the non-jumping state, and the total jump time (Fₜ) is calculated by subtracting the time (T_{off}) according to the non-jump time (Tₙ) and the offset value from the play time (Sₜ). However, the method for calculating the total jump time (Fₜ) is not limited to the example. For example, each jump time may be calculated on the basis of the timing of the n-th transition to the non-jumping state and the timing of (n+1)th transition to the non-jumping state, and the total jump time (Fₜ) may be calculated by adding the calculated jump times.

Note that the present invention is not limited to the configurations described here, and may include combinations of the configurations or the like described in the above embodiments with other elements, and the like. These points can be changed without departing from the spirit of the present invention, and can be appropriately determined according to application modes of the points.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A measurement method executed by a processor included in a computer, the measurement method comprising:
acquiring scan data indicating a distance to a dent region generated in a bed portion of a trampoline and a direction of the dent region from a laser scanner device arranged below the bed portion and which scans a direction approximately parallel to the bed portion with laser light;
specifying a center position of the dent region based on the acquired scan data; and
calculating a landing position of a player of a trampoline competition on the bed portion based on the specified center position.

2. The measurement method according to claim 1,
wherein the specifying includes specifying the center position of the dent region by calculating a shape of a cross section of the dent region based on the acquired scan data.

3. The measurement method according to claim 2,
wherein the acquiring includes acquiring scan data from the laser scanner device arranged at a position corresponding to at least one or more vertices of four vertices of the bed portion.

4. The measurement method according to claim 2, further comprising
determining whether the player of the trampoline competition is in a non-jumping state by determining whether a position on a two-dimensional coordinate plane of the acquired scan data is included in the bed portion.

5. The measurement method according to claim 4,
wherein the calculating the shape of the cross section includes fitting a circular shape to each position on the two-dimensional coordinate plane of the acquired scan data for one time of scanning.

6. The measurement method according to claim 5,
wherein the calculating the landing position includes averaging respective center positions of a plurality of cross sections calculated by performing scanning with the laser light a plurality of times while the player is in the non-jumping state.

7. The measurement method according to claim 4, further comprising
calculating a non-jump time of the player using the number of times of scanning with the laser light while the player is in the non-jumping state.

8. The measurement method according to claim 7, further comprising
calculating a total jump time of the player by subtracting each non-jump time calculated when the player transitions to the non-jumping state from a play time of the player.

9. The measurement method according to claim 8,
wherein the calculating the total jump time includes further subtracting a time according to a distance between the bed portion and a scan surface scanned with the laser light from the play time of the player.

10. A measurement system comprising:
a memory; and
a processor coupled to the memory and configured to:
acquire scan data indicating a distance to a dent region generated in a bed portion of a trampoline and a direction of the dent region from a laser scanner device arranged below the bed portion and which scans a direction approximately parallel to the bed portion with laser light,
specify a center position of the dent region based on the acquired scan data; and
calculate a landing position of a player of a trampoline competition on the bed portion based on the specified center position.

11. A non-transitory computer-readable storage medium storing a program that cause a processor included in a computer to execute a process, the process comprising:
acquiring scan data indicating a distance to a dent region generated in a bed portion of a trampoline and a direction of the dent region from a laser scanner device arranged below the bed portion and which scans a direction approximately parallel to the bed portion with laser light;
specifying a center position of the dent region based on the acquired scan data; and
calculating a landing position of a player of a trampoline competition on the bed portion based on the specified center position.
